(19) United States
(12) Patent Application Publication
(10) Pub. No.: US 2026/0292529 A1
(43) Pub. Date: Sep. 24, 2026

(54) ARIS LOCATION SELECTION UNDER ARIS-ASSISTED WIRELESS NETWORK

(71) Applicant: LENOVO (BEIJING) LIMITED, Beijing (CN)

(72) Inventors: Tingnan Bao, Beijing (CN); Jianfeng Wang, Beijing (CN); Haiming Wang, Beijing (CN); Lihua Yang, Beijing (CN)

(21) Appl. No.: 19/476,350

(22) PCT Filed: Apr. 19, 2023
(86) PCT No.: PCT/CN2023/089189

§ 371 Date: Oct. 17, 2025

(51) Int. Cl. H04W 16/26; H04B 7/04

(52) U.S. Cl. CPC H04W 16/26; H04B 7/04013

(57) ABSTRACT

Methods and apparatuses for location selection of ARIS are disclosed. In one embodiment, a base unit comprises a transceiver; and a processor coupled to the transceiver, wherein the processor is to cause the base unit to: determine a target area; determine an expected phase shift coefficient for an ARIS at each of multiple time points according to the target area and a trajectory of the ARIS, where each time point corresponds to a location of the ARIS along the trajectory; assign the expected phase shift coefficients at the multiple time points to the ARIS; transmit a reference signal to the ARIS at each of the multiple time points, wherein, the ARIS forwards the reference signal at each time point using the expected phase shift coefficient at the time point; receive signal qualities measured at the multiple time points; determine the best signal quality from the signal qualities measured at the multiple time points; and determine the location corresponding to the the time point at which the best signal quality is measured as the optimal location of the ARIS.

### FIELD

The subject matter disclosed herein generally relates to wireless communications, and more particularly relates to methods and apparatuses for aerial re-configurable intelligent surface (ARIS) location selection under ARIS-assisted wireless network.

### BACKGROUND

Reconfigurable Intelligent Surface (RIS) is a large and thin metasurface of metallic or dielectric material, comprised of an array of passive sub-wavelength scattering elements with specially designed physical structure. The elements can be controlled in a software-defined manner to change the electromagnetic (EM) properties (e.g., phase shift and/or amplitude attenuation) of the reflection of the incident radio frequency (RF) signals. By a joint phase control of all scattering elements (e.g., by a phase shift coefficient), the reflected radiation pattern of the incident RF signals can be arbitrarily tuned in real time.

Unmanned aerial vehicles (UAVs) are becoming increasingly popular in various industries, including telecommunications. UAVs can be used to improve wireless communication by acting as a relay or by providing additional coverage. UAVs can be deployed in areas where infrastructure is lacking, such as disaster-stricken regions or remote locations. UAVs can also be used to provide temporary coverage for events or in areas where the network is congested. UAVs equipped with wireless communication technology can act as aerial base stations and provide a reliable connection to ground-based devices.

A RIS can be deployed on a UAV. Such deployed RIS can be referred to as aerial RIS (ARIS).

This invention targets location selection of the ARIS.

### BRIEF SUMMARY

Methods and apparatuses for location selection of ARIS are disclosed.

In one embodiment, a base unit comprises a transceiver; and a processor coupled to the transceiver, wherein the processor is to cause the base unit to: determine a target area; determine an expected phase shift coefficient for an ARIS at each of multiple time points according to the target area and a trajectory of the ARIS, where each time point corresponds to a location of the ARIS along the trajectory; assign the expected phase shift coefficients at the multiple time points to the ARIS; transmit a reference signal to the ARIS at each of the multiple time points, wherein, the ARIS forwards the reference signal at each time point using the expected phase shift coefficient at the time point; receive signal qualities measured at the multiple time points; determine the best signal quality from the signal qualities measured at the multiple time points; and determine the location corresponding to the time point at which the best signal quality is measured as the optimal location of the ARIS.

In some embodiment, the processor is to cause the base unit to further determine the expected phase shift coefficient at the time point corresponding to the optimal location as the optimal phase shift coefficient for the ARIS at the optimal location.

In some embodiment, the multiple time points include an initial time point corresponding to an initial location of the ARIS. The processor is to cause the base unit to further determine the expected phase shift coefficient for the ARIS at the initial time point according to an estimated channel, and the target area is determined according to path-loss effect of the estimated channel.

In some embodiment, the processor is to cause the base unit to further transmit a notification to a UE in the target area to instruct the UE to send the signal qualities measured at the multiple time points in a single report. The single report may include multiple entries each of which includes a time point and a SINR or RSRP at the time point. The notification may be contained in a DCI. The DCI may contain 1 bit.

In another embodiment, a method performed at a base unit comprises: determining a target area; determining an expected phase shift coefficient for an ARIS at each of multiple time points according to the target area and a trajectory of the ARIS, where each time point corresponds to a location of the ARIS along the trajectory; assigning the expected phase shift coefficients at the multiple time points to the ARIS; transmitting a reference signal to the ARIS at each of the multiple time points, wherein, the ARIS forwards the reference signal at each time point using the expected phase shift coefficient at the time point; receiving signal qualities measured at the multiple time points; determining the best signal quality from the signal qualities measured at the multiple time points; and determining the location corresponding to the time point at which the best signal quality is measured as the optimal location of the ARIS.

In still another embodiment, a UE comprises a transceiver; and a processor coupled to the transceiver, wherein the processor is to cause the UE to: receive a reference signal forwarded by an ARIS at each of multiple time points using an expected phase shift coefficient at the time point; and if any one of signal qualities measured at the multiple time points is lower than a predetermined threshold, send, to a base unit, a measurement report including all signal qualities measured at the multiple time points.

In some embodiment, the measurement report is contained in a MAC CE. The MAC CE may include multiple entries each of which includes a time point and a SINR or RSRP at the time point.

In yet another embodiment, a method performed at a UE comprises receiving a reference signal forwarded by an ARIS at each of multiple time points using an expected phase shift coefficient at the time point, and if any one of signal qualities measured at the multiple time points is lower than a predetermined threshold, sending, to a base unit, a measurement report including all signal qualities measured at the multiple time points

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of ARIS deployed in a wireless system;

FIGS. 2(a), 2(b) and 2(c) illustrate different locations of the ARIS at different time points;

FIG. 3 illustrates a procedure according to a first embodiment;

FIG. 4 illustrates a procedure according to a second embodiment;

FIG. 5 illustrates a procedure according to a third embodiment;

FIG. 6 is a schematic flow chart diagram illustrating an embodiment of a method;

FIG. 7 is a schematic flow chart diagram illustrating another embodiment of a method; and

FIG. 8 is a schematic block diagram illustrating apparatuses according to one embodiment.

### DETAILED DESCRIPTION

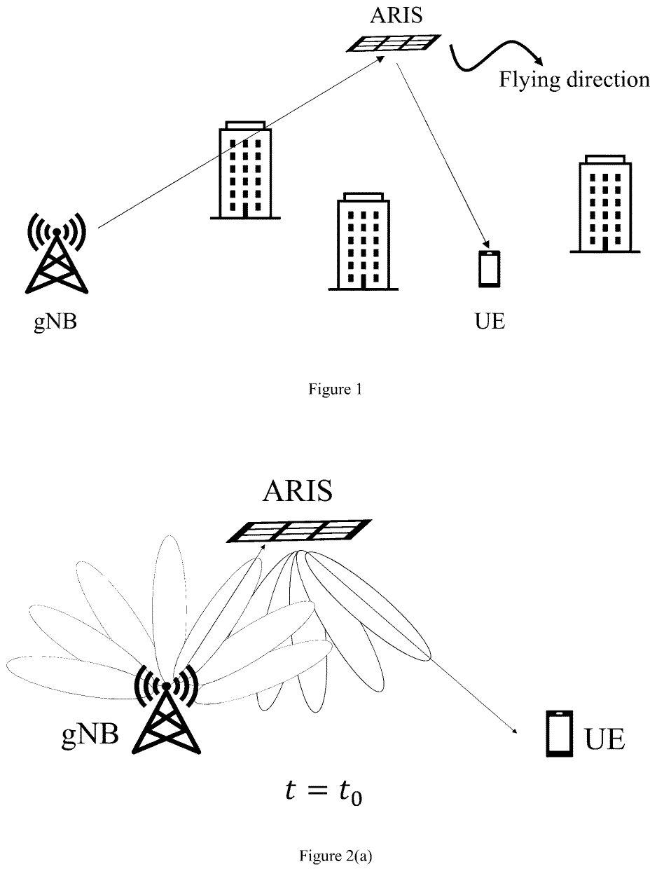

UAV can be considered as an aerial relay or base station to cover a large area. Conventional RIS is a stationary technology to improve the signal quality in a specific area with less power consumption. When RIS is deployed on UAV, the RIS on the UAV is referred to as an ARIS. ARIS can be deployed in an example scenario illustrated in FIG. 1. For example, the ARIS can be flexibly deployed in a disaster area or crowded environment where ground based RISs can be difficult to be deployed. Besides, the line of sight (LoS) link can be easily established with the deployment of ARIS. Moreover, due to RIS's passive characteristic that does not require any power source, ARIS can provide reliable and high-quality communication while reducing the energy consumption. As a result, by leveraging the mobility and passive nature of UAVs and RISs, ARIS can improve coverage, capacity, flexibility, and energy efficiency in dynamic and challenging wireless environments.

This disclosure proposes an ARIS location determination scheme under ARIS-assisted wireless network.

As shown in FIG. 1, an ARIS is deployed to enhance the link between the gNB and the serving UE. The following assumptions are assumed:

The air interface between the gNB and the ARIS can be either a known interface, e.g., Uu interface if ARIS is regarded as a special UE, or a newly defined interface if the ARIS is regarded as a new kind of network node.

The ARIS can be fully controlled by the gNB via the air interface between the gNB and the ARIS.

The ARIS is a passive ARIS.

The ARIS can move in the air without the limitation of the predefined trajectory. It means that the trajectory of the ARIS can be controlled, e.g., by gNB.

The gNB controls the ARIS by control information. The control information includes at least a phase shift coefficient of the ARIS, where the phase shift coefficient can control the direction of reflected signal by the ARIS.

ARIS is moved and controlled by gNB to improve the link performance of the UE in a target area. That is, gNB can control a trajectory of the ARIS.

In addition, an example of the ARIS is described as follows: the ARIS has M reflection elements and the diagonal reflection matrix of the ARIS is denoted by Ø=diag(Ø₁, Ø₂, . . . , Ø_{M}), where Øₘ=aₘe^{jθ}^{ₘ} is the m^{th} reflection coefficient of the ARIS with aₘ and θₘ representing its amplitude and phase, where m is from 1 to M. In a practical ARIS, it is assumed that aₘ=1. The phase shift coefficient is a set of N discrete value, which can be shown as γ={e^{jθ}^{ₘ}|θₘ∈{0, Δθ, . . . , (N−1)Δθ}, N≥2}, where Δθ=2π/N.

The ARIS is controlled by the gNB to move in the air to find an optimal location that can provide the best performance to a target area where the serving UE (which means a UE served by the gNB) is located.

Similar to a traditional RIS, for a given area, the ARIS has an optimal phase shift coefficient at a given position. To obtain the optimal phase shift coefficient at the given position, the following procedure can be performed.

For example, the optimal phase shift coefficient at a first location is determined as follows: the gNB controls the ARIS to move to the first location, and controls the ARIS to stop (i.e., hold) at the first location. The gNB can determine the optimal phase shift coefficient for the ARIS at the first location when the ARIS stops at the first location. For example, the gNB sends a reference signal to the ARIS which forwards the reference signal by using multiple discrete phase shift coefficients to the UE. The gNB determines the optimal phase shift coefficient for the ARIS at the first location based on a report (e.g., CSI report) fed back by the UE that includes signal qualities (e.g., L1-SINRs or L1-RSRPs) measured under the multiple discrete phase shift coefficients. For example, the phase shift coefficient under which the best signal quality (e.g., the maximum value of L1-SINRs or L1-RSRPs) is measured is determined as the optimal phase shift coefficient for the ARIS at the first location.

Thereafter, the gNB will control the ARIS to move to a second location, and repeat the same procedure to determine the optimal phase shift coefficient for the ARIS at the second location.

As a whole, the gNB has to control the ARIS to move to all candidate locations, and determines the optimal phase shift coefficient of the ARIS at each candidate location.

When the optimal phase shift coefficients of the ARIS at all candidate locations are determined, the gNB will determine an optimal location from all candidate locations. For example, among the maximum values of L1-SINRs or L1-RSRPs measured at all candidate locations, a maximum value of the maximum values can be determined, and the location corresponding to the maximum value of the maximum values can be determined as the optimal location.

To perform the above procedures, the system computational complexity is relative high.

In view of the above, this disclosure proposes a simple method to determine the optimal location for the ARIS.

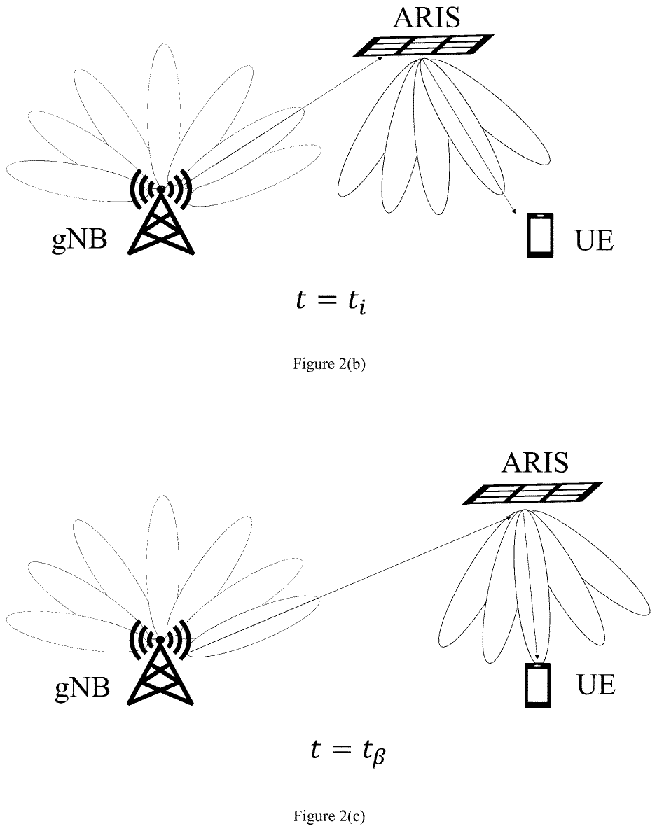

At first, an initial location of the ARIS is determined. For example, at t=t₀ as shown in FIG. 2(a), the initial location of the ARIS can be directly above the gNB. The optimal phase shift coefficient of the ARIS at the initial location can be obtained by the same method as described above. In addition, when the optimal phase shift coefficient of the ARIS at the initial location is obtained, the target area where the UE is located can be determined. So, an expected optimal phase shift coefficient of the ARIS at any other location (e.g., location #x) can be determined according to the target area and the location #x.

With the expected optimal phase shift coefficient of the ARIS at location #x, the ARIS does not have to stop at the location #x to obtain all L1-SINRs or L1-RSRPs measured at the location #x, where each L1-SINR or L1-RSRP is measured at one of multiple discrete phase shift coefficients configured to the ARIS at the location #x.

Instead, if the expected optimal phase shift coefficient of the ARIS at location #x is determined, the UE can only measure the L1-SINR or L1-RSRP at the location #x when the ARIS uses the expected optimal phase shift coefficient to forward the reference signal. For example, as shown in FIG. 2(b), at t=tᵢ, the ARIS is at location #i, and the expected optimal phase shift coefficient #i is configured to the ARIS. So, the UE can measure the L1-SINR or L1-RSRP in the condition that the ARIS forwards the reference signal by using the expected optimal phase shift coefficient #i, and send the measured L1-SINR or L1-RSRP to the gNB. Incidentally, since the UE only measures one L1-SINR or L1-RSRP at one location #x, the ARIS is not necessary to have to be stopped at location #x.

Accordingly, the gNB can obtain the measured L1-SINRs or L1-RSRPs at all candidate locations (i.e., from location #0 to location #β), where location #β corresponds to the last time point t=t_{β} (e.g., at t=t_{β}, the ARIS is above the UE as shown in FIG. 2(c)).

As a whole, the gNB can determine the maximum value of all measured signal qualities (e.g., L1-SINRs or L1-RSRPs), each of which is measured at one candidate location. The location corresponding to the maximum value can be determined as the optimal location, while the expected optimal phase shift coefficient of the ARIS at the optimal location can be determined as the optimal phase shift coefficient of the ARIS.

Based on the above analysis, three embodiments are proposed for implementation.

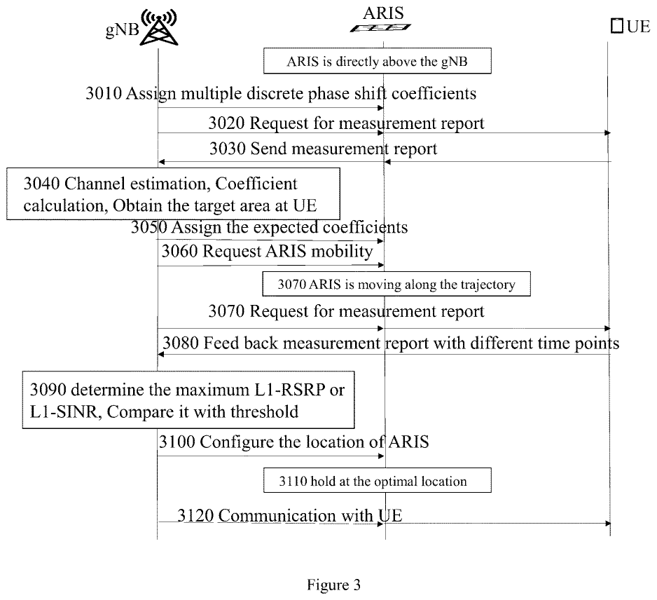

FIG. 3 illustrates a procedure according to the first embodiment.

An example of the initial point of the ARIS is directly above the gNB. In addition, it is assumed that the communication between the gNB and the UE is at least via the ARIS.

In step 3010, the gNB assigns multiple discrete phase shift coefficients to the ARIS when the ARIS is at the initial location.

In step 3020, the gNB sends a request to the UE for a measurement report. For example, the gNB sends a reference signal while the ARIS forwards the reference signal by using each of the multiple discrete phase shift coefficients, respectively.

In step 3030, upon receiving the request, the UE measures L1-RSRPs or L1-SINRs, each of which is obtained based on one of the multiple discrete phase shift coefficients used by the ARIS. The UE sends a measurement report (e.g., CSI report) including the measured L1-RSRPs or L1-SINRs to the gNB.

In step 3040, the gNB firstly estimates the channel based on the received measurement report. In addition, according to the estimated channel, the gNB calculates the optimal phase shift coefficient of the ARIS at the initial point (e.g., directly above the gNB). For example, the phase shift coefficient corresponding to the largest measured L1-RSRP or L1-SINR contained in the measurement report is determined as the optimal phase shift coefficient of the ARIS at the initial point. Moreover, the gNB obtains the target area where the UE is located based on the path-loss effect of the estimated channel.

Since the ARIS is controlled by the gNB, the gNB can control the trajectory of the ARIS (e.g., from directly above the ARIS to above the UE). In addition, it is assumed that the gNB also controls the speed and/or direction of the ARIS along the trajectory. It means that the gNB knows the location of the ARIS at each time point (which can be represented by unit of millisecond (ms), time slot or symbol, etc). In other words, each location of the ARIS corresponds to a time point. Accordingly, based on the target area where the UE is located, the gNB can determine an expected phase shift coefficient of the ARIS at each time point, where each time point corresponds to a location of the ARIS along the trajectory.

In step 3050, the gNB assigns the expected phase shift coefficients, each of which is associated with one time point, to the ARIS. For example, the expected phase shift coefficients can take the form as shown in Table 1

TABLE 1

| Time point (slot | Expected phase |
|---|---|
| or symbol or ms) | shift coefficient |
| t₁ | Coefficient #1 |
| t₂ | Coefficient #2 |
| . . . | . . . |
| t_{β} | Coefficient #β |

It can be seen from Table 1 that at each time point tᵢ, e.g., i=1, 2, . . . , β, where β is the last time point, which may correspond to the end of the trajectory (e.g., the ARIS is above the UE), an expected phase shift coefficient #i is assigned to the ARIS. It means that each expected phase shift coefficient #i is effective at time point tᵢ. That is, the ARIS forwards the signal using the expected phase shift coefficient #i at time point tᵢ.

In step 3060, the gNB sends a request to the ARIS to control the ARIS to move along the trajectory, e.g., from directly above the gNB to above the UE.

In step 3070, when the ARIS is moving along the trajectory, the gNB sends a request to the UE for measurement report including L1-RSRPs or L1-SINRs at all time points tᵢ. For example, the gNB sends a reference signal at each time point tᵢ when the expected phase shift coefficient #i of the ARIS is effective. Alternatively to assigning all expected phase shift coefficients #1 to #β to the ARIS in step 3050, the gNB may assign each expected phase shift coefficient #i to the ARIS just before sending the reference signal at each time point tᵢ.

Accordingly, the UE can measure a L1-RSRP or L1-SINR at each time point tᵢ. In step 3080, the UE sends the measured L1-RSRP or L1-SINR at each time point tᵢ to the gNB.

In step 3090, the gNB determines the largest L1-RSRP or L1-SINR from the L1-RSRPs or L1-SINRs reported in step 3080 and the largest L1-RSRP or L1-SINR reported in step 3030 (which is the L1-RSRP or L1-SINR measured at t=t₀ when the optimal phase shift coefficient for the ARIS at t=t₀ is used). Preferably, the determined largest L1-RSRP or L1-SINR is compared with a predefined threshold. If the determined largest L1-RSRP or L1-SINR is larger than the predefined threshold, the gNB determines that a good signal quality can be obtained.

As an example, it is assumed that L1-RSRP or L1-SINR #j associated with the time point tⱼ is determined as the largest L1-RSRP or L1-SINR and is larger than the predefined threshold. Accordingly, the location corresponding to the time point tⱼ associated with the largest L1-RSRP or L1-SINR (i.e., L1-RSRP or L1-SINR #j) is determined as the optimal location of the ARIS. In addition, and the expected phase shift coefficient #j assigned to the time point tⱼ is determined as the optimal phase shift coefficient associated with the optimal location of the ARIS.

In step 3100, the gNB configures the optimal location to the ARIS, e.g., by control information.

In step 3110, the ARIS moves to the optimal location and holds at the optimal location, and uses the optimal phase shift coefficient (e.g., phase shift coefficient #j) associated with the optimal location.

In step 3120, the communication between gNB and the UE via the ARIS can be performed, in the condition that the ARIS holds at the optimal location and uses the optimal phase shift coefficient.

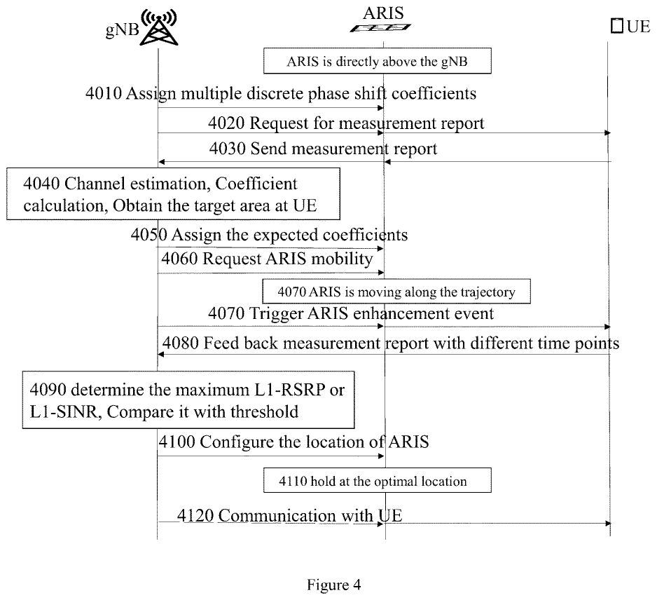

FIG. 4 illustrates a procedure according to the second embodiment.

The second embodiment differs from the first embodiment in that the gNB explicitly triggers ARIS enhancement event. It means that the gNB explicitly triggers the UE to report a single measurement report including all measured L1-RSRPs or L1-SINRs, each of which is measured on one time point tᵢ, where i is from 1 to β.

In particular, steps 4010-4060 are the same as steps 3010-3060.

In step 4070, when the ARIS is moving along the trajectory, the gNB firstly sends the UE a DCI with 1 bit as defined in Table 2, to trigger ARIS enhancement event in addition to sending a reference signal at each time point tᵢ when the expected phase shift coefficient #i of the ARIS is effective. Moreover, each expected phase shift coefficient #i may be assigned to the ARIS just before sending the reference signal at each time point tᵢ instead of assigning all expected phase shift coefficients #1 to #β to the ARIS in step 4050.

TABLE 2

| Bit field mapped | |
|---|---|
| to index | Triggered ARIS measurement |
| 0 | No gNB-triggered ARIS measurement |
| 1 | Enable gNB-triggered ARIS measurement |

If the 1 bit is set to ‘1’ (i.e., “Enable gNB-triggered ARIS measurement”), it means that the UE shall measure L1-RSRPs or L1-SINRs, each of which is measured on one time point tᵢ, where i is from 1 to β, and send a single measurement report including all measured L1-RSRPs or L1-SINRs. In other words, when the ARIS enhancement event is triggered, the UE shall send a single measurement report (e.g., CSI report) including all measured L1-RSRPs or L1-SINRs in step 4080. For example, the single measurement report may take the form as shown in Table 3.

TABLE 3

| Time point (slot or | |
|---|---|
| symbol or ms) | The received value |
| t₀ | L1-RSRP or L1-SINR #0 |
| t₁ | L1-RSRP or L1-SINR #1 |
| t₂ | L1-RSRP or L1-SINR #2 |
| . . . | . . . |
| t_{β} | L1-RSRP or L1-SINR #β |

The L1-RSRP or L1-SINR #0 is optionally contained in the measurement report. The L1-RSRP or L1-SINR #0 is measured at time point t₀, which is the initial time point that corresponds to the initial location. So, the L1-RSRP or L1-SINR #0 is the largest L1-RSRP or L1-SINR contained in the measurement report in step 4030.

Incidentally, if the 1 bit is set to ‘0’ (i.e., “No gNB-triggered ARIS measurement”), the UE may measure a L1-RSRP or L1-SINR at each time point tᵢ, and send the measured L1-RSRP or L1-SINR at each time point tᵢ to the gNB.

In step 4090, the gNB determines the largest L1-RSRP or L1-SINR from the L1-RSRPs or L1-SINRs reported in step 4080 if L1-RSRP or L1-SINR #0 is contained. On the other hand, if L1-RSRP or L1-SINR #0 is not contained in the measurement report in step 4080, the gNB determines the largest L1-RSRP or L1-SINR from the L1-RSRPs or L1-SINRs contained in the measurement report in step 4080 and L1-RSRP or L1-SINR #0 determined in step 4040. Preferably, the determined largest L1-RSRP or L1-SINR is compared with a predefined threshold. If the determined largest L1-RSRP or L1-SINR is larger than the predefined threshold, the gNB determines that a good signal quality can be obtained.

Steps 4100-4120 are the same as steps 3100-3120.

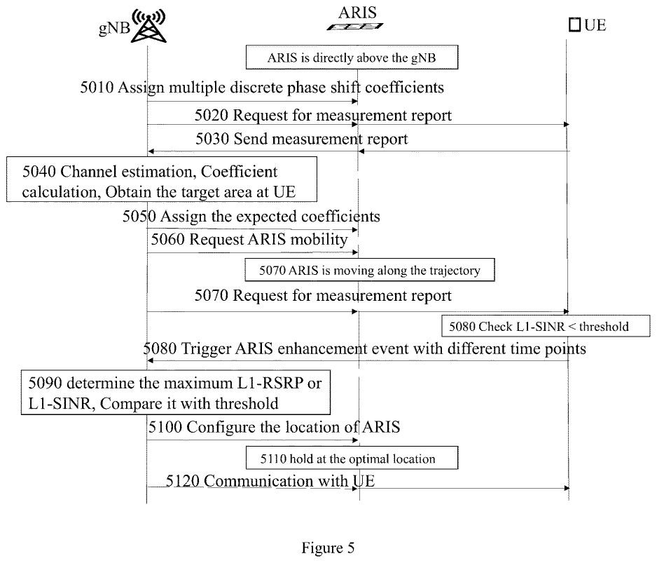

FIG. 5 illustrates a procedure according to the third embodiment.

The third embodiment differs from the first embodiment in that the ARIS enhancement measurement report is triggered or requested by UE.

Steps 5010-5070 are the same as steps 3010-3070.

Different from step 3080 in which the UE sends back a measured L1-RSRP or L1-SINR at each time point tᵢ to the gNB, in step 5080, after the UE measures a L1-RSRP or L1-SINR at a time point tᵢ, the UE compares the measured L1-RSRP or L1-SINR at tᵢ with a predefined threshold. If the measured L1-RSRP or L1-SINR at tᵢ is larger than the predefined threshold, the UE only stores the measured L1-RSRP or L1-SINR associated with the time point tᵢ but does not send back the measured L1-RSRP or L1-SINR. The UE measures a L1-RSRP or L1-SINR at next time point tᵢ₊₁, and compares the measured L1-RSRP or L1-SINR at tᵢ₊₁ with the predefined threshold. If the measured L1-RSRP or L1-SINR at tᵢ₊₁ is larger than the predefined threshold, the same process continues to next time point tᵢ₊₂.

On the other hand, if the measured L1-RSRP or L1-SINR at any time point (e.g., at tⱼ) is lower than the predefined threshold, the UE triggers ARIS enhancement measurement report. In particular, the UE may send a MAC CE including all measured L1-RSRPs or L1-SINRs in step 5080. It means that the MAC CE will be sent after the UE measures L1-RSRP or L1-SINR #β at the last time point t_{β}.

The contents included in the MAC CE can be similar to the contents in Table 3. For example, the MAC CE may take the form as shown in Table 4, where Cᵢ is indicated as 1 bit.

TABLE 4

| | | | | | | | |
|---|---|---|---|---|---|---|---|
| C₇ | C₆ | C₅ | C₄ | C₃ | C₂ | C₁ | C₀ |

| | |
|---|---|
| R | t₀ |
| R | L1-RSRP or L1-SINR #0 (i.e., at t₀) |
| R | t₁ |
| R | L1-RSRP or L1-SINR #1 (i.e., at t₁) |
| . . . | . . . |
| R | t_{β} |
| R | L1-RSRP or L1-SINR #β (i.e., at t_{β}) |

That is, each of tᵢ and L1-RSRP or L1-SINR #i, where i is from 0 to β, may have 7 bits. “R” indicates a reserved bit.

The fields t₀ and the L1-RSRP or L1-SINR #0 are contained optionally in the MAC CE.

A dedicated PUCCH-SR resource can be configured for the UE to request a PUSCH for transmission of the MAC CE.

Steps 5090-5120 are the same as steps 3090-3120.

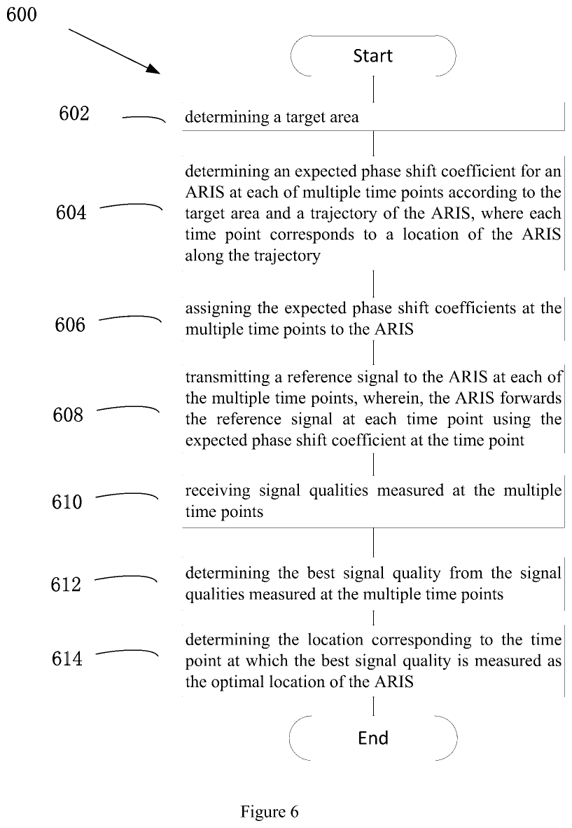

FIG. 6 is a schematic flow chart diagram illustrating an embodiment of a method 600 according to the present application. In some embodiments, the method 600 is performed by an apparatus, such as a base station of a serving cell. In certain embodiments, the method 600 may be performed by a processor executing program code, for example, a microcontroller, a microprocessor, a CPU, a GPU, an auxiliary processing unit, a FPGA, or the like.

The method 600 may include 602 determining a target area; 604 determining an expected phase shift coefficient for an ARIS at each of multiple time points according to the target area and a trajectory of the ARIS, where each time point corresponds to a location of the ARIS along the trajectory; 606 assigning the expected phase shift coefficients at the multiple time points to the ARIS; 608 transmitting a reference signal to the ARIS at each of the multiple time points, wherein, the ARIS forwards the reference signal at each time point using the expected phase shift coefficient at the time point; 610 receiving signal qualities measured at the multiple time points; 612 determining the best signal quality from the signal qualities measured at the multiple time points; and 614 determining the location corresponding to the time point at which the best signal quality is measured as the optimal location of the ARIS.

In some embodiment, the method further comprises determining the expected phase shift coefficient at the time point corresponding to the optimal location as the optimal phase shift coefficient for the ARIS at the optimal location.

In some embodiment, the multiple time points include an initial time point corresponding to an initial location of the ARIS. The method may further comprise determining the expected phase shift coefficient for the ARIS at the initial time point according to an estimated channel, and the target area is determined according to path-loss effect of the estimated channel.

In some embodiment, the method further comprises transmitting a notification to a UE in the target area to instruct the UE to send the signal qualities measured at the multiple time points in a single report. The single report may include multiple entries each of which includes a time point and a SINR or RSRP at the time point. The notification may be contained in a DCI. The DCI may contain 1 bit.

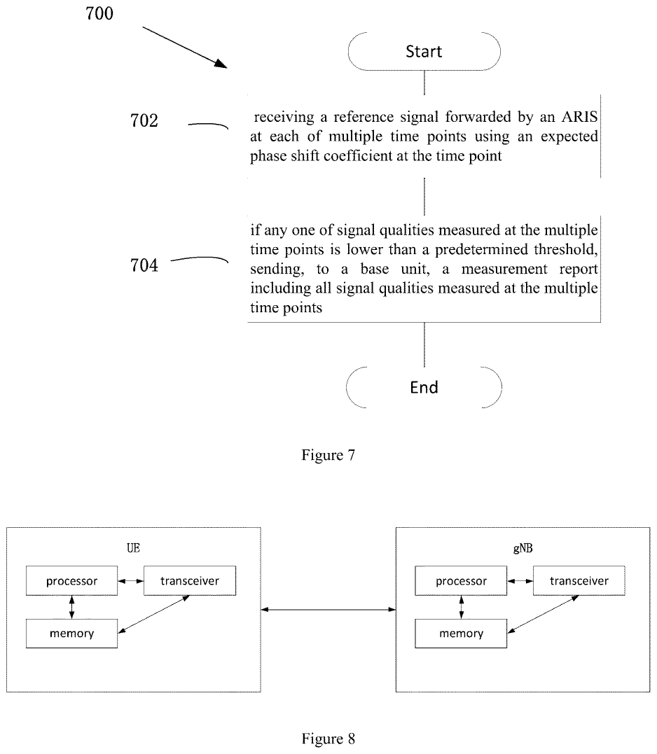

FIG. 7 is a schematic flow chart diagram illustrating an embodiment of a method 700 according to the present application. In some embodiments, the method 700 is performed by an apparatus, such as a base station of a serving cell. In certain embodiments, the method 700 may be performed by a processor executing program code, for example, a microcontroller, a microprocessor, a CPU, a GPU, an auxiliary processing unit, a FPGA, or the like.

The method 700 may include 702 receiving a reference signal forwarded by an ARIS at each of multiple time points using an expected phase shift coefficient at the time point, and 704 if any one of signal qualities measured at the multiple time points is lower than a predetermined threshold, sending, to a base unit, a measurement report including all signal qualities measured at the multiple time points.

In some embodiment, the measurement report is contained in a MAC CE. The MAC CE may include multiple entries each of which includes a time point and a SINR or RSRP at the time point.

FIG. 8 is a schematic block diagram illustrating apparatuses according to one embodiment.

Referring to FIG. 8, the base station (e.g., gNB) includes a processor, a memory, and a transceiver that is a transmitter and/or a receiver. The processors implement a function, a process, and/or a method which are proposed in FIG. 6.

The base station comprises a transceiver; and a processor coupled to the transceiver, wherein the processor is to cause the base unit to: determine a target area; determine an expected phase shift coefficient for an ARIS at each of multiple time points according to the target area and a trajectory of the ARIS, where each time point corresponds to a location of the ARIS along the trajectory; assign the expected phase shift coefficients at the multiple time points to the ARIS; transmit a reference signal to the ARIS at each of the multiple time points, wherein, the ARIS forwards the reference signal at each time point using the expected phase shift coefficient at the time point; receive signal qualities measured at the multiple time points; determine the best signal quality from the signal qualities measured at the multiple time points; and determine the location corresponding to the time point at which the best signal quality is measured as the optimal location of the ARIS.

In some embodiment, the processor is to cause the base unit to further determine the expected phase shift coefficient at the time point corresponding to the optimal location as the optimal phase shift coefficient for the ARIS at the optimal location.

In some embodiment, the multiple time points include an initial time point corresponding to an initial location of the ARIS. The processor is to cause the base unit to further determine the expected phase shift coefficient for the ARIS at the initial time point according to an estimated channel, and the target area is determined according to path-loss effect of the estimated channel.

In some embodiment, the processor is to cause the base unit to further transmit a notification to a UE in the target area to instruct the UE to send the signal qualities measured at the multiple time points in a single report. The single report may include multiple entries each of which includes a time point and a SINR or RSRP at the time point. The notification may be contained in a DCI. The DCI may contain 1 bit.

The UE includes a processor, a memory, and a transceiver that is a transmitter and/or a receiver. The processors implement a function, a process, and/or a method which are proposed in FIG. 7.

The UE comprises a transceiver; and a processor coupled to the transceiver, wherein the processor is to cause the UE to: receive a reference signal forwarded by an ARIS at each of multiple time points using an expected phase shift coefficient at the time point; and if any one of signal qualities measured at the multiple time points is lower than a predetermined threshold, send, to a base unit, a measurement report including all signal qualities measured at the multiple time points.

In some embodiment, the measurement report is contained in a MAC CE. The MAC CE may include multiple entries each of which includes a time point and a SINR or RSRP at the time point.

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A base unit, comprising:
at least one memory; and
at least one processor coupled with the at least one memory and configured to cause the base unit to:
determine a target area;
determine an expected phase shift coefficient for an aerial re-configurable intelligent surface (ARIS) at each of multiple time points according to the target area and a trajectory of the ARIS, wherein each of the multiple time points corresponds to a location of the ARIS along the trajectory;
assign the expected phase shift coefficients at the multiple time points to the ARIS;
transmit a reference signal to the ARIS at each of the multiple time points, wherein the ARIS forwards the reference signal at each of the multiple time points using the expected phase shift coefficient at the time point;
receive signal qualities measured at the multiple time points;
determine a best signal quality from the signal qualities measured at the multiple time points; and
determine the location corresponding to a time point at which the best signal quality is measured as an optimal location of the ARIS.

2. The base unit of claim 1, wherein the at least one processor is configured to cause the base unit to determine the expected phase shift coefficient at the time point corresponding to the optimal location as an optimal phase shift coefficient for the ARIS at the optimal location.

3. The base unit of claim 1, wherein the multiple time points include an initial time point corresponding to an initial location of the ARIS.

4. The base unit of claim 3, wherein the at least one processor is configured to cause the base unit to determine the expected phase shift coefficient for the ARIS at the initial time point according to an estimated channel, and wherein the target area is determined according to a path-loss effect of the estimated channel.

5. The base unit of claim 1, wherein the at least one processor is configured to cause the base unit to transmit a notification to a user equipment (UE) in the target area to instruct the UE to send the signal qualities measured at the multiple time points in a single report.

6. The base unit of claim 5, wherein the single report includes multiple entries each of which includes a time point and a signal-to-interference-plus-noise ratio (SINR) or reference signal received power (RSRP) at the time point.

7. The base unit of claim 5, wherein the notification is contained in a downlink control information (DCI).

8. The base unit of claim 7, wherein the DCI contains 1 bit.

9. A method performed by a base unit, comprising:
determining a target area;
determining an expected phase shift coefficient for an aerial re-configurable intelligent surface (ARIS) at each of multiple time points according to the target area and a trajectory of the ARIS, wherein each of the multiple time points corresponds to a location of the ARIS along the trajectory;
assigning the expected phase shift coefficients at the multiple time points to the ARIS;
transmitting a reference signal to the ARIS at each of the multiple time points,
wherein the ARIS forwards the reference signal at each of the multiple time points using the expected phase shift coefficient at the time point;
receiving signal qualities measured at the multiple time points;
determining a best signal quality from the signal qualities measured at the multiple time points; and
determining the location corresponding to a time point at which the best signal quality is measured as an optimal location of the ARIS.

10. A user equipment (UE), comprising:
at least one memory; and
at least one processor coupled with the at least one memory and configured to cause the UE to:
receive a reference signal forwarded by an aerial re-configurable intelligent surface (ARIS) at each of multiple time points using an expected phase shift coefficient at the time point; and
if any one of signal qualities measured at the multiple time points is lower than a predetermined threshold, send, to a base unit, a measurement report including signal qualities measured at the multiple time points.

11. The UE of claim 10, wherein the measurement report is contained in a medium access control control element (MAC CE).

12. The UE of claim 11, wherein the MAC CE includes multiple entries each of which includes a time point and a signal-to-interference-plus-noise ratio (SINR) or reference signal received power (RSRP) at the time point.

13. A method performed by a user equipment (UE), comprising:
receiving a reference signal forwarded by an aerial re-configurable intelligent surface (ARIS) at each of multiple time points using an expected phase shift coefficient at the time point; and
if any one of signal qualities measured at the multiple time points is lower than a predetermined threshold, sending, to a base unit, a measurement report including signal qualities measured at the multiple time points.

14. The method claim 9, further comprising determining the expected phase shift coefficient at the time point corresponding to the optimal location as an optimal phase shift coefficient for the ARIS at the optimal location.

15. The method claim 9, wherein the multiple time points include an initial time point corresponding to an initial location of the ARIS.

16. The method claim 15, further comprising determining the expected phase shift coefficient for the ARIS at the initial time point according to an estimated channel, and wherein the target area is determined according to a path-loss effect of the estimated channel.

17. The method claim 9, further comprising transmitting a notification to a user equipment (UE) in the target area to instruct the UE to send the signal qualities measured at the multiple time points in a single report.

18. The method claim 17, wherein the single report includes multiple entries each of which includes a time point and a signal-to-interference-plus-noise ratio (SINR) or reference signal received power (RSRP) at the time point.

19. The method claim 17, wherein the notification is contained in a downlink control information (DCI).

20. The method claim 19, wherein the DCI contains 1 bit.
